(19) United States
(12) Patent Application Publication
(10) Pub. No.: US 2007/0110088 A1
(43) Pub. Date: May 17, 2007

(54) METHODS AND SYSTEMS FOR SCALABLE INTERCONNECT

(75) Inventors: Michael F. Kemp, Ottawa (CA); Sylvio Bisson, Secteur Aylmer (CA)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: Liquid Computing Corporation, Ottawa (CA)

(21) Appl. No.: 11/530,410

(22) Filed: Sep. 8, 2006

Related U.S. Application Data
(60) Provisional application No. 60/736,106, filed on Nov. 13, 2005.

(51) Int. Cl. H04L 12/56

(52) U.S. Cl. 370/419

(57) ABSTRACT

Embodiments of the present invention define a modular architecture that provides the physical level of interconnect that is used to cost effectively deploy high performance and high flexibility communication networks. Aspects of the physical communications are described to deliver scalable computer to computer communications as well as scalable computer to I/O communications, scalable I/O to I/O communications, and scalable function to function communications with a low cable count. Embodiments of the present invention focus on the physical switched communications layer, as the interconnect physical layer, functions, chassis; modules have been designed as an integrated solution.

This application claims the benefit under 35 U.S.C. §119(e) of provisional application Ser. No. 60/736,106, filed Nov. 12, 2006, which application is hereby incorporated herein in its entirety.

### BACKGROUND OF THE INVENTION

1. Field of the Invention

Embodiments of the present invention relate to communications networks that interconnect multiple servers together. More specifically, embodiments of the present invention relate to a subset of the communications interconnect functionality, including chassis based interconnect topology, multi-chassis based interconnect topology including cabling strategy and switch strategy (not including switch logical elements), and physical modularity of the functions that comprise the interconnect system.

2. Description of the Prior Art and Related Information

The ever growing need for computational performance in both the high performance and Enterprise market segments has conventionally been met through the deployment of ever larger networks of servers to scale the computational cycles in line with demand. As the number of servers or specialized computers grows, the complexity and costs associated with deploying networks of servers grow exponentially, performance declines and flexibility becomes more limited.

The computer industry's investment in building more powerful servers and processor chips is absolutely required, but it is not solving the core problem, as demand is increasing at a faster rate. The fundamental solution to this problem lies not within the realm of computing but within the realm of communications. That is, to solve these problems, computer and server communication networks must be significantly improved to permit the computational assets to be easily deployed, to enable high performance, and to deliver flexibility in the deployment of assets.

Conventional approaches to defining the overall communications solution space have been characterized by a number of initiatives for high performance and enterprise networking. Such conventional approaches are briefly discussed hereunder.

Network of Servers: This is where servers to be networked are provisioned with a specific network interface and a discrete network is built to connect them. Typical networks include the widely deployed Ethernet; Infiniband or Myrinet standards based HPC networking technologies and proprietary. The main problems with the network of servers approach include the following:
The networks require professional service to put them together and they become complex to manage;
Most servers are set up for limited I/O so it is costly or not even feasible to scale throughput bandwidth beyond that which is typically required in the large Enterprise market;
HPC standards based and proprietary networks solve some of the performance problems but they are still expensive and acquisition and management costs scale in a nonlinear manner. They typically do not solve the throughput scaling problems since servers do not have the requisite I/O bandwidth.
All such solutions are expensive from a cabling perspective.

Networks of Blade Servers: This is where several blade servers are connected using a local copper connectivity medium to provide the first stage of physical interconnect. Networking of the blades servers is carried out in a manner that is similar to that used in individual servers, except that each unit includes a greater number of processors. Architectures for the blade servers come in several forms, including PCI or VersaModule Eurocard (VME) standards based chassis, which include a VME, PCI or other standards based bus running along a backplane. Blade servers may also be provided in an ATCA based standard chassis. The ATCA (Advanced Telecom & Computing Architecture) represents the industry's leading edge initiative to define a standards based high performance chassis that can be used for converged computing and communications applications. FIG. 1 shows a diagram of an ATCA chassis 10. The ATCA chassis 10 includes a backplane 12 that provides mesh connect to up to sixteen multi-function slots 14, (Function Slot 1 to Function Slot 16). A set of links 16 from each multi-function slot 14 to the backplane 12 includes four bi-directional lanes to every other multi-function slot 14. Each multi-function slot 14 is equipped to receive a function module (not shown). Growing the ATCA beyond one shelf (chassis) requires the addition of a separate network, shown in FIG. 2.

FIG. 2 illustrates an expanded ATCA system 20 comprising 2 or more ATCA chassis 10, each linked to an external switching network 22. The separate external switching network 22 may be an Ethernet, Infiniband, Myrinet or proprietary network. The multi-function slots 14 in each ATCA chassis 10 are plug-in slots for the insertion of function modules, as shown in FIG. 2. Such function modules may be designed for I/O, processing, and to provide network connectivity. For example the multi-function slots 1 to 15 in each of the ATCA chassis 10 may be used for function modules “Function 1” to “Function 15”, and the multi-function slots 16 in each of the ATCA chassis 10 may be used for network connectivity modules “Connect 16.” The network connectivity modules may then be used to provide the connectivity to the external switching network 22. The number of multi-function slots 14 in each ATCA chassis 10 that are available for pure processing is correspondingly decreased by the number of connectivity modules (“Connect 16”) necessary for interconnection to the external network 22. A distinction is made between “slots” (such as function slots 14) providing plug-in space and interconnect, and function modules (such as “Function 1”) which may be inserted in a “slot.”

Many proprietary chassis have been developed. Those developed by the data communications industry are often built around a 1+1 switch solution. This is shown in FIGS. 3a and 3b. FIG. 3a illustrates a logical view of a typical communications chassis 30, including N function slots 32 (“Function slot 1” to “Function slot N”) and two switch slots 34 (“Switch slot 1” and “Switch slot 2”). Each of the switch slots 34 is connected to each of the function slots 32, through backplane connections 36. FIG. 3b shows the physical arrangement of function modules (“function 1” to “function N”) and switch modules (“switch 1” and “switch 2”) in the communications chassis 30.

As with ATCA, proprietary chassis may also be networked via an external network. Many companies in the computer industry build proprietary blade servers. (e.g., Egenera, IBM, HP to name but a few). They have external I/O but they are designed as self contained units. They still require external networking. Blade servers solve some problems because they enable the first stage of connectivity within the chassis. However, blade servers have not been designed for inter-chassis connectivity, which must be overlaid.

Problems commonly associated with blade servers include the following:
PCI or VME standards based chassis simply do not have the bandwidth to be even considered for demanding applications;
ATCA based standard chassis. The ATCA is the leading edge standards based solution in the marketplace. The ATCA based standard chassis requires an external network to scale, the slots for networking reduce the slots available for processors, and the connectivity bandwidth is insufficient;
Typical proprietary chassis designed for data communications applications (there are hundreds) do not provide the connectivity richness or the interconnect capability to provide the throughput bandwidth required for the most demanding applications. Like ATCA, these too require external networking to scale the system.

There are many proprietary blade server products, generally built as self-contained compute platforms. While they have external I/O built in, such functionality is believed to be insufficient to connect the blades in a sufficiently high performance manner.

Proprietary Massively Parallel Architectures: IBM and Cray have built machines with massively parallel architectures that have built-in communications over thousands of processors. (IBM=Blue Gene, and Cray=Redstorm, for example). Both (Blue Gene and Redstorm) are built around toroidal connectivity. FIG. 4 shows a high-level representation of this type of architecture, including the logical connectivity. Illustrated in FIG. 4 is a typical massively parallel architecture 40, including a number of function slots 42 (Function Slots 1 to Function Slot P+N), divided into groups of N function slots each. A first group 44 of N function slots comprises the Function Slots 1 to Function Slot N, a second group 46 of N function slots comprises the Function Slots N+1 to Function Slot 2N, and so on to a last group 48 of N function slots comprising the Function Slots P+1 to Function Slot P+N. The function slots 42 within each of the groups (44 to 48) are interconnected by a Partial Toroidal Connectivity 50. This is to say that, for example, the N function slots 42 of the first group 44 (the Function Slots 1 to Function Slot N) are connected as a partial toroid (a ring, or a toroid of higher dimension). The groups 44 to 48 are themselves interconnected through one or more rings by links 52 joining the Partial Toroidal Connectivities 50 (only two rings shown symbolically).

Proprietary massively parallel architectures are designed with intrinsic scalability. Some of the problems commonly associated with these approaches are as follows:
Processor locality becomes a limiting factor, since getting between the furthest apart processors may take several hops, which negatively impacts latency and throughput performance;
As a result of the above, the computational algorithmic flexibility is limited;
Routing algorithms through the toroid become more complex as the system scales;
The network routing topology changes as nodes are taken out and back into service;
The bisectional bandwidth ratio drops as the system scales (to less than 10% in some systems for example), meaning that resources cannot be flexibly allocated as locality is directly proportional to performance.

Mainframes and Proprietary SMP Architectures: There are a variety of machines that use custom backplanes for tightly connecting together groups of processors for very high performance applications. These classes of machines are typically designed as a point solution for a specific size. They either do not readily scale or they have set configurations and tend to be limited in scope. To network them, external networks are required.

I/O Communications: None of the above solutions have a flexible, scalable and high bandwidth I/O solution. The conventional solution to I/O is to connect I/O server gateways to the internal network and channeling all I/O through these servers. In many cases these become bottlenecks, or limiting factors in I/O performance

### SUMMARY OF THE INVENTION

Accordingly, an embodiment of the present invention is an interconnect system that may include a chassis; a plurality N of function modules housed in the chassis, and an interconnect facility. The interconnect facility may include a plurality P of switch planes and a plurality of point-to-point links, each of the plurality of point-to-point links having a first end coupled to one of the plurality N of function modules and a second end coupled to one of the plurality P of switch planes such that each of the plurality P of switch planes is coupled to each of the plurality N of function modules by one of the plurality of point-to-point links.

Each of the plurality P of switch planes may add 1/p^{th} incremental bandwidth to the interconnect system and a maximum bandwidth of the interconnect system may be equal to the product of P and the bandwidth of the plurality of point-to-point links. Each of the plurality P of switch planes may be independent of others of the plurality of P switch planes. Each of the plurality N of function modules may be configured for one or more of I/O functions, visualization functions, processing functions, and to provide network connectivity functions, for example. Each of the plurality of point-to-point links may be bi-directional. Each of the plurality of links may include a cable. Each of the plurality of links may include one or more electrically conductive tracks disposed on a substrate.

According to another embodiment, the present invention is a method for providing interconnectivity in a computer. The method may include steps of providing a chassis, the chassis including N function slots and P interconnect slots for accommodating up to N function modules and up to P interconnect modules; providing a plurality of bi-directional point-to-point links, and coupling respective ones of the plurality of links between each of the N function slots and each of the P interconnect slots. The coupling step may be effective to provide a total available switched bandwidth B in the chassis, the total available bandwidth B being defined as the product of P and the bandwidth of the plurality of bi-directional point-to-point links.

The providing step may be carried out with the plurality of bi-directional point-to-point links each including one or more electrically conductive tracks disposed on a substrate.

According to yet another embodiment, the present invention is a computer chassis. The chassis may include a plurality N of function slots, each of the plurality N of function slots being configured to accommodate a function module; a plurality P of interconnect slots, each of the plurality P of interconnect slots being configured to accommodate an interconnect module, and a plurality of bi-directional point-to-point links. Each of the plurality of bi-directional point-to-point links may have a first end coupled to one of the plurality N of function slots and a second end coupled to one of the plurality P of interconnect slots such that each of the plurality P of interconnect slots is coupled to each of the plurality N of function slots by one of the plurality of bi-directional point-to-point links. Each of the plurality of bi-directional point-to-point links may include a cable. Each of the plurality of bi-directional point-to-point links may include one or more electrically conductive tracks disposed on a substrate. Each of the plurality P of interconnect slots may be configured to accommodate an independent communication network. The computer chassis may further include a function module inserted in one or more of the plurality N of function slots. The function module may be operative, for example, to carry out I/O functions, visualization functions, processing functions, and/or to provide network connectivity functions. The computer chassis may further include an interconnect module inserted in one or more of the plurality P of interconnect slots. The computer chassis may further include a switch module inserted into one of the plurality of P of interconnect slots, the switch module being operative to activate 1/p^{th} of a total available switched bandwidth B in the chassis. The total available switched bandwidth B may be the product of P and the bandwidth of each bi-directional point-to-point link. The computer chassis may also include a plurality of function modules, each of the plurality of function modules being inserted in a respective one of the plurality N of function slots, and a single chassis switch module inserted into one of the plurality of P of interconnect slots. The single chassis switch module may be configured to provide switched connectivity between the plurality of function modules.

The present invention, according to yet another embodiment, is a multichassis computer connectivity system that includes a first chassis including a plurality N1 of function slots, each configured to accommodate a function module; a plurality P1 of interconnect slots, each configured to accommodate an interconnect module, each of the plurality P1 of interconnect slots being coupled to each of the plurality N1 of function slots by respective first bi-directional point-to-point links, and a first connection interface module inserted into one of the plurality P1 of interconnect slots; a second chassis including a plurality N2 of function slots, each configured to accommodate a function module; a plurality P2 of interconnect slots, each configured to accommodate an interconnect module, each of the plurality P2 of interconnect slots being coupled to each of the plurality N2 of function slots by respective second bi-directional point-to-point links, and a second connection interface module inserted into one of the plurality P2 of interconnect slots, and an external switch coupled to the first and second connection interface modules. The first and second connection interface modules and the external switch may be configured to enable traffic to be switched between any one of the plurality N1 of function slots and any one of the plurality N2 of function slots.

The external switch may be coupled to the first and second connection interface modules relays by first and second electrically driven links. The external switch may be coupled to the first and second connection interface modules by first and second optically driven links. Each of the respective first and second bi-directional point-to-point links may include a cable. Each of the respective first and second bi-directional point-to-point links may include one or more electrically conductive tracks disposed on a substrate. Each of the plurality P1 and P2 of interconnect slots may be configured to accommodate an independent communication network.

The multichassis computer connectivity system may further include a first function module inserted in one or more of the plurality N1 of function slots, and a second function module inserted in one or more of the plurality N2 of function slots. The first and second function modules may be operative to carry out I/O functions, visualization functions, processing functions and/or to provide network connectivity functions, for example. The multichassis computer connectivity system may further include a first interconnect module inserted in one or more of the plurality P1 of interconnect slots, and a second interconnect module inserted in one or more of the plurality P2 of interconnect slots. The first connection interface module may be configured to switch traffic between the plurality N1 of function slots without routing the traffic to the external switch. The second connection interface module may be configured to enable traffic between the plurality N2 of function slots without routing the traffic to the external switch. The first connection interface module may be configured to switch traffic from one of the plurality N1 of function slots through the external switch only when the traffic is destined to one of the plurality N2 of function slots. The second connection interface module may be configured to switch traffic from one of the plurality N2 of function slots through the external switch only when the traffic is destined to one of the plurality N1 of function slots.

According to yet another embodiment, the present invention is a computer chassis. The computer chassis may include a midplane; a plurality of connectors coupled to the midplane; a plurality N of function slots, each of the plurality N of function slots being configured to accommodate a function module; a plurality P of interconnect slots, each of the plurality P of interconnect slots being configured to accommodate an interconnect module to enable traffic to be selectively switched, through the plurality of connectors and the midplane, between the plurality N of function slots and between any one of the plurality N of function slots and a network external to the computer chassis; a plurality of full-duplex point-to-point links, each of the full duplex point-to-point links being coupled between one of the plurality N of function slots and one of the plurality of connectors or between one of the plurality P of interconnect slots and one of the plurality of connectors. Each of the plurality P of interconnect slots may be configured to accommodate an independent communication network. The computer chassis may further include a function module inserted in one or more of the plurality N of function slots. The function module may be operative to carry out I/O functions, visualization functions, processing functions and/or to provide network connectivity functions, for example. The computer chassis may further include an interconnect module inserted in one or more of the plurality P of interconnect slots. The interconnect module may include a switch module, the switch module being operative to activate 1/p^{th} of a total available switched bandwidth in the computer chassis. The computer chassis may further include a plurality of function modules, each of the plurality of function modules being inserted in a respective one of the plurality N of function slots, and a single chassis switch module inserted into one of the plurality of P of interconnect slots, the single chassis switch module being configured to provide switched connectivity between the plurality N of function modules within the computer chassis. The computer chassis may further include a connection interface module inserted into one of the plurality P of interconnect slots, the connection interface module being configured to enable traffic to be switched between any one of the plurality P of function modules and a network external to the computer chassis through an external switch. Each of the plurality of full-duplex point-to-point links may include one or more electrically conductive tracks disposed on a substrate. Each of the plurality P of interconnect slots may be configured to accommodate an independent communication network. The function module may be operative to carry out I/O functions, visualization functions, processing functions and/or to provide network connectivity functions, for example. The connection interface module may be configured to switch traffic between the plurality N of function slots without routing the traffic to a switch that is external to the computer chassis. The computer chassis may further include a plurality of compute modules inserted into respective ones of the plurality N of function slots, each of the plurality of compute modules including at least one processor; a plurality of I/O modules inserted in respective other ones of the plurality N of function slots, and one or more switching modules inserted in one of the plurality P of interconnect slots, the switching module(s) being configured to switch traffic between any one of the compute and I/O modules within the computer chassis.

According to a still further embodiment thereof, the present invention is a multichassis computational system that may include a first chassis, the first chassis including a first midplane; a plurality N1 of function slots, each being coupled to the first midplane and configured to accommodate a function module; a plurality P1 of interconnect slots, each being coupled to the first midplane, configured to accommodate an interconnect module and being coupled to each of the plurality N1 of function slots; and a first multi chassis switch module inserted into one of the plurality P1 of interconnect slots; a second chassis, the second chassis including a second midplane; a plurality N2 of function slots, each being coupled to the second midplane and configured to accommodate a function module; a plurality P2 of interconnect slots, each being coupled to the second midplane, configured to accommodate an interconnect module and being coupled to each of the plurality N2 of function slots; and a second multi chassis switch module inserted into one of the plurality P2 of interconnect slots, and an inter chassis switch module coupled to each of the first and second multi chassis switch module and configured to switch traffic between any of the plurality N1 of function slots through the first multi chassis switch module and any of the plurality N2 of function slots through the second multi chassis switch module.

The inter chassis switch module may be external to the first and/or to the second chassis. The multichassis computational system may further include a first plurality of conductors coupled to the first midplane, and a first plurality of full-duplex point-to-point links, each of the first plurality of full duplex point-to-point links being coupled between one of the plurality N1 of function slots and one of the first plurality of conductors or between one of the plurality P1 of interconnect slots and one of the first plurality of connectors. The multichassis computational system may further include a second plurality of conductors coupled to the second midplane, and a second plurality of full-duplex point-to-point links, each of the second plurality of full duplex point-to-point links being coupled between one of the plurality N2 of function slots and one of the plurality of conductors or between one of the plurality P2 of interconnect slots and one of the second plurality of connectors. Each of the plurality P1 and P2 of interconnect slots may be configured to accommodate an independent communication network. The multichassis computational system may further include a first function module inserted in one or more of the plurality N1 of function slots and a second function module inserted in one or more of the plurality N2 of function slots. The first and second function modules may be operative to carry out I/O functions, visualization functions, processing functions and/or to provide network connectivity functions, for example. The multichassis computational system may further include a first interconnect module inserted in one of the plurality P1 of interconnect slots and a second interconnect module inserted in one of the plurality P2 of interconnect slots. The first multi chassis switch module may also be configured to switch traffic from one of the plurality N1 of function slots to any other one of the plurality N1 of function slots without routing the traffic outside of the first chassis. The second multi chassis switch module may also be configured to switch traffic from one of the plurality N2 of function slots to any other one of the plurality N2 of function slots without routing the traffic outside of the second chassis. Each of the first plurality of full-duplex point-to-point links may include one or more electrically conductive tracks disposed on a substrate. Each of the second plurality of full-duplex point-to-point links may include one or more electrically conductive track disposed on a substrate. Each of the plurality P1 and P2 of interconnect slots may be configured to accommodate an independent communication network. The first chassis further may include a first plurality of compute modules inserted into respective ones of the plurality N1 of function slots. Each of the first plurality of compute modules may include one or more processors and a first plurality of I/O modules inserted in respective other ones of the plurality N1 of function slots. The first multi chassis switch module may be further configured to switch traffic between any one of the first plurality of compute and I/O modules within the first chassis. The second chassis may further include a second plurality of compute modules inserted into respective ones of the plurality N2 of function slots, each of the second plurality of compute modules including at least one processor, and a second plurality of I/O modules inserted in respective other ones of the plurality N2 of function slots. The second multi chassis switch module may be further configured to switch traffic between any one of the second plurality of compute and I/O modules within the second chassis.

### BRIEF DESCRIPTION OF THE DRAWINGS

FIG. 1 illustrates aspects of a conventional ATCA chassis 10 with full mesh connectivity.

FIG. 2 is a diagram illustrating an expanded ATCA system 20 of conventional ATCA chassis 10 using an external network 22;

FIGS. 3a and 3b show logical and physical aspects respectively of a conventional switched chassis architecture 30;

FIG. 4 shows aspects of a conventional massively parallel architecture 40;

FIG. 5 shows a system that includes a plurality of computational hosts, each of which may include one or more processors, according to an embodiment of the present invention;

FIG. 6 shows a logical network topology 60, according to an embodiment of the present invention;

FIG. 7 shows the logical connectivity scheme 70 within a chassis, according to an embodiment of the present invention;

FIG. 8 shows a Single Chassis connectivity scheme 80, based on the logical connectivity scheme 70 of FIG. 7, including a switching function that provides switched connectivity between the function modules within the single chassis, according to further aspects of embodiments of the present invention;

FIG. 9 is a block diagram illustrating a Multi-Chassis connectivity scheme 90 with external switching, according to an embodiment of the present invention;

FIG. 10 is a block diagram illustrating another Multi-Chassis connectivity scheme 100, with chassis based switching as well as external switching, according to an embodiment of the present invention;

FIG. 11 shows an exemplary embodiment of a midplane based chassis 110 that is an enabler for a target network topology, according to an embodiment of the present invention;

FIG. 12 shows a computational system 120 based on the midplane based chassis 110 of FIG. 11, illustrating a midplane provisioned with an I/O module, 20 compute modules and one switch module, according to an embodiment of the present invention; and

FIG. 13 shows an exemplary multichassis computational system 130, including a Multi-Chassis Switch Module (MCSM) provisioned in the midplane, and “Q” chassis networked via an Inter-Chassis Switch Module (ICSM) and cabling, according to an embodiment of the present invention. Also shown is one I/O module (IOM) provisioned per chassis.

### DETAILED DESCRIPTION

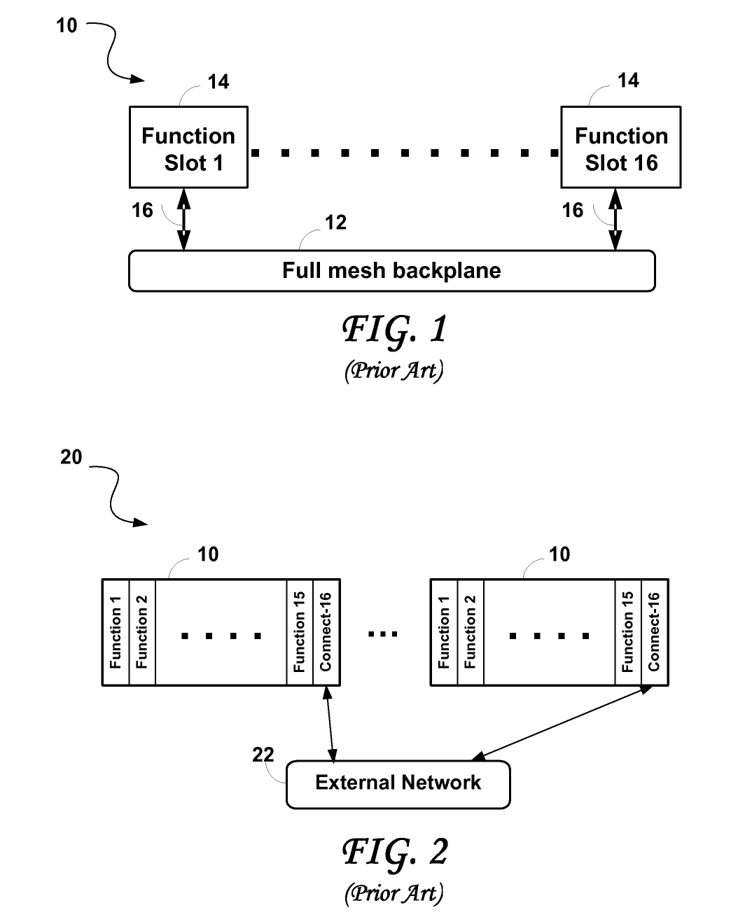

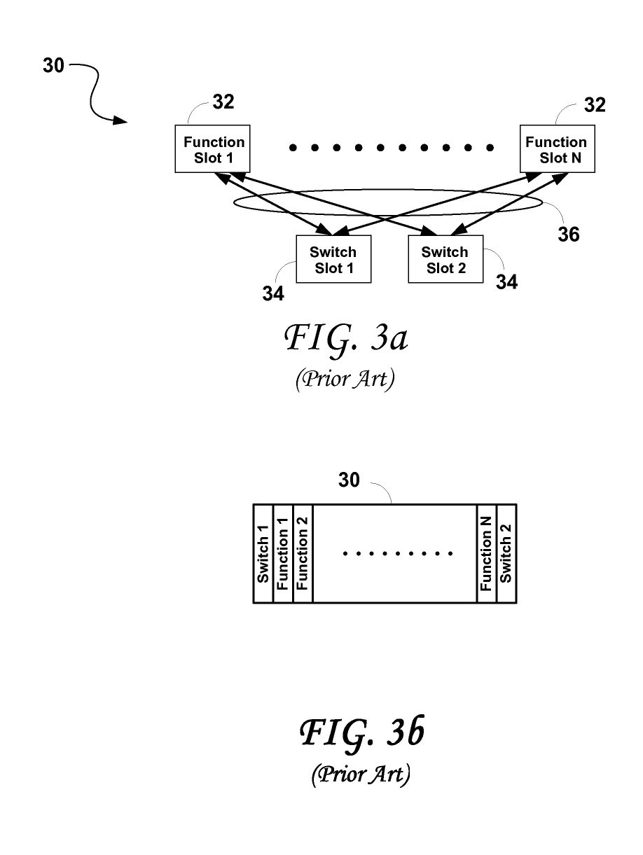

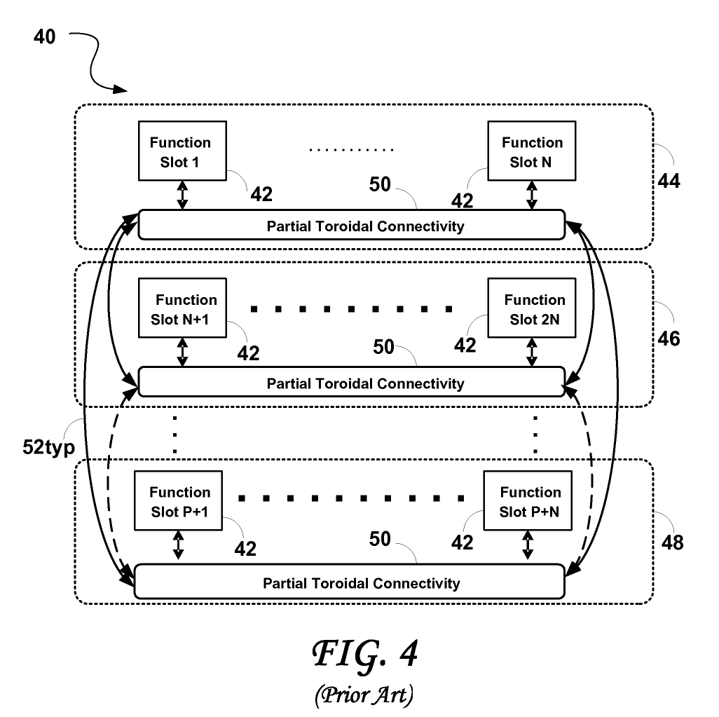

Embodiments of the present invention address a subset of the communications networking problem. Specifically, embodiments of the present invention provide a modular architecture that provides the physical level of interconnect that is used to cost effectively deploy high performance and high flexibility computer networks. It addresses the physical communications aspect to deliver scalable computer to computer communications as well as scalable computer to I/O communications, scalable I/O to I/O communications, and scalable communications between any other functionality. Embodiments of the present invention focus on the physical switched communications layer. The interconnect physical layer including chassis and function slots, and the function modules have been designed as an integrated solution. A distinction is made between “slots” in a chassis (such as function slots 14 in FIG. 1) providing plug-in space and interconnect, and function modules (such as “Function 1” in FIG. 2) which may be inserted in a “slot.”

The Physical Network

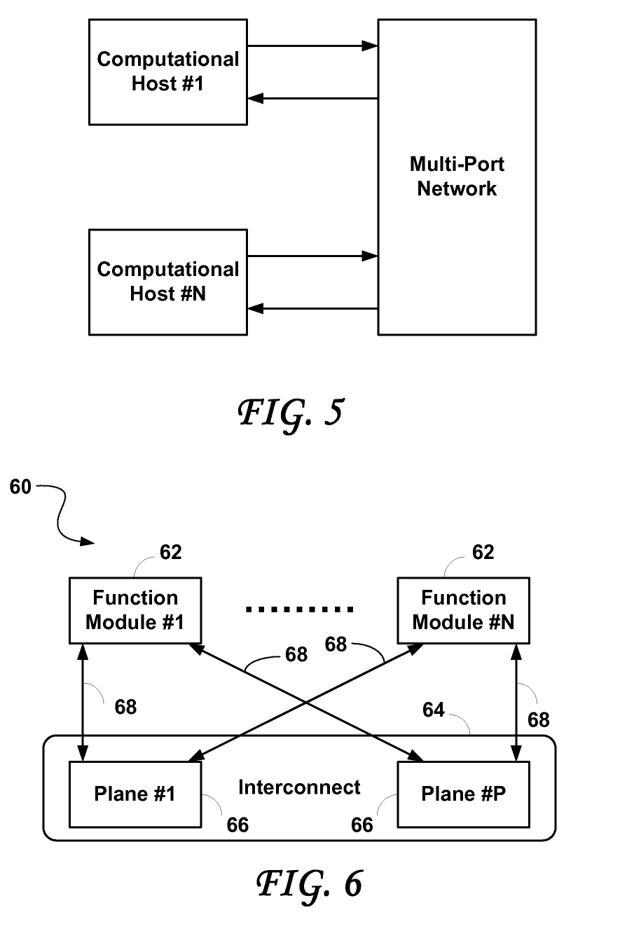

The logical network topology of an embodiment of the present invention is shown in FIG. 5. FIG. 5 shows a system comprised of a plurality N of Computational Hosts (Computational Host #1 to Computational Host #N) and a Multi-Port Network. The Multi-Port Network may be configured to connect N function modules (the Computational Hosts) all of which may have the same or different performance characteristics. The function modules (the Computational Hosts in this embodiment) may further include and/or support any function. For example, such functions may include, without limitation, compute intensive functions, Digital Signal Processing (DSP) intensive functions, I/O functions, visualization functions, and the like. The Multi-Port Network is generic: it is not specific to any function communications type. Moreover, the Multi-Port Network is not constrained by physical realization (e.g., chassis constraints), which impact many conventional solutions. The Multi-Port Network may be configured to provide full connectivity between all functions. An important parameter is the bisectional bandwidth ratio (BB-ratio, the ratio of the bandwidth available at any layer in the network to the bandwidth of the ports). The BB-ratio is preferably equal to 1 (unity) when the network is fully built out, for most flexible and powerful network performance, however the BB-ratio may be less than 1, depending on the communications needs of the function modules. The function module interconnect bandwidth may readily scale by adding more switch planes (shown in FIG. 6 below).

FIG. 6 shows a logical network topology (system) 60, comprising Function Modules 62 (Function Module #1 to Function Module #N) and an Interconnect 64 that includes a plurality P of Switch Planes 66 (Plane #1 to Plane #P). Up to “P” switch planes may be connected to the Function Modules 62 through individual links 68. Each Switch Plane 66 adds 1/p^{th} incremental bandwidth, where the maximum bandwidth is equal to the product of p and the individual link (68) bandwidth. In the network of FIG. 6, all interconnect is preferably point-to-point for high availability. Each Switch Plane (network plane) 66 may be completely independent. The only place the network planes 66 may converge is at the function modules 62. There are preferably multiple paths through the switched interconnect system (the Interconnect 64), which enables the implementation of advanced load balancing techniques. All dimensions of the network may be scaled by adding additional electronic modules.

Physical Network Connectivity

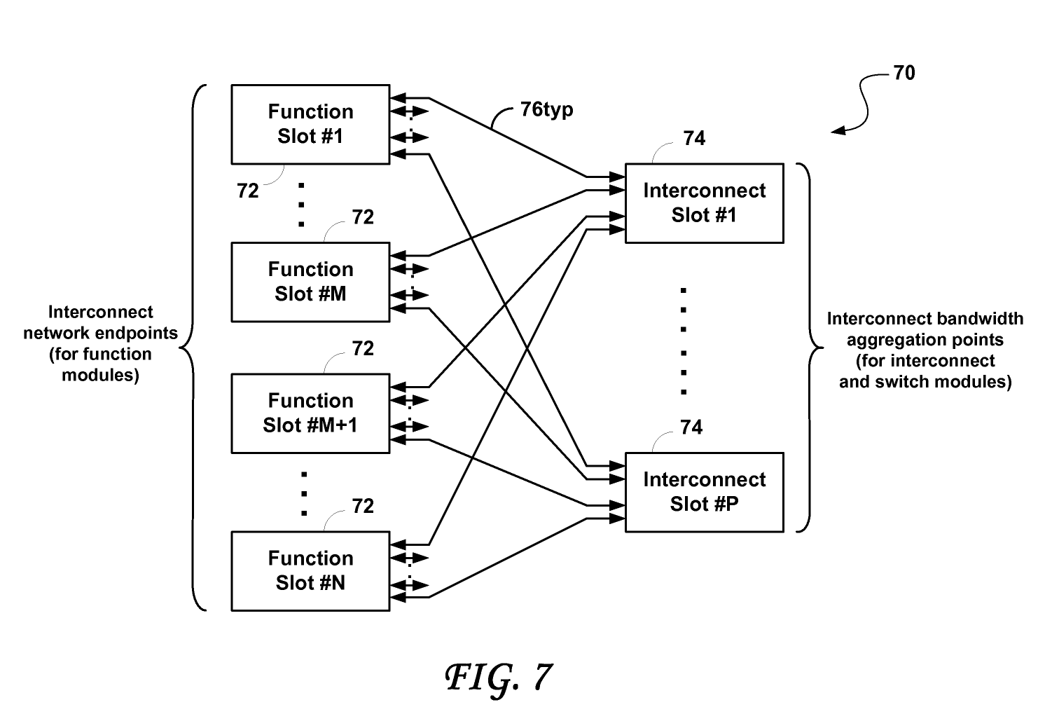

A key building block of a scalable network topology that scales seamlessly beyond a single chassis, as shown in FIG. 6, is the method for internal connectivity within the chassis. FIG. 7 shows a logical internal chassis connectivity scheme 70 that enables a plurality of modules to be connected. The physical connectivity may include copper tracks on a substrate material, which provides the physical form, mechanical strength, base for mounting electrical connectors, and the ability to support the high speed characteristics required for the interconnect links.

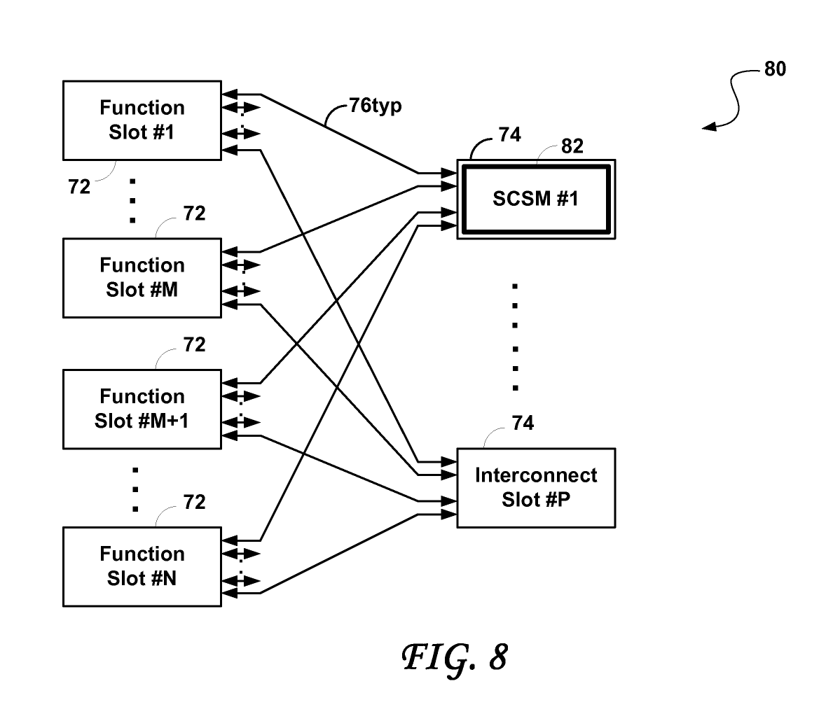

The connectivity scheme 70 depicted in FIG. 7 provides N function slots 72, each of which may accommodate a function module (not shown) and P interconnect slots 74, each of which may accommodate an interconnect module or a switched interconnect module (modules not shown). Connectivity between the function slots 72 and the interconnect slots 74 may be configured as follows. Each of the “N” function slots 72 may be connected or otherwise coupled to each of the “P” interconnect slots 74 via bi-directional point-to-point links 76. Similarly, each of the “P” interconnect slots 74 may be connected or otherwise coupled to all “N” function slots 72 via the bi-directional point to point links 76. Each of the P interconnect slots 74 may be used for (accommodate) completely independent communication networks. The only place where connectivity from each of the “P” communication networks converges may be at each function slot 72. The connections at the function slots 72 are referred to herein as “network endpoints”, as these provide a termination point of the communications network. The connections at the interconnect slots 74 are referred to herein as “bandwidth aggregation points.” This is because these connections may represent points at which a subset of the network bandwidth converges. At these points, switched interconnect functions may be added to physically build out the network. This is referred to herein as a “Bandwidth Aggregation Architecture” and it provides tremendous flexibility, and interconnection cable count reduction. Examples of preferred network topologies include Single Chassis Switching, which is a switching function that provides switched connectivity between the function modules within a single chassis, as shown in FIG. 8.

FIG. 8 shows a Single Chassis connectivity scheme 80 that is derived from the connectivity scheme 70 of FIG. 7 by adding a Single Chassis Switch Module (SCSM) 82 in one of the “P” interconnect switch slots 74, for example the Interconnect Slot #1. In this way 1/p^{th} of the total available switched bandwidth has been activated (where the total available switched bandwidth is the product of P and the bandwidth of each point-to-point link 76). The switched bandwidth may be flexibly scaled by adding more SCSMs 82, up until all P interconnect slots 74 have been provisioned.

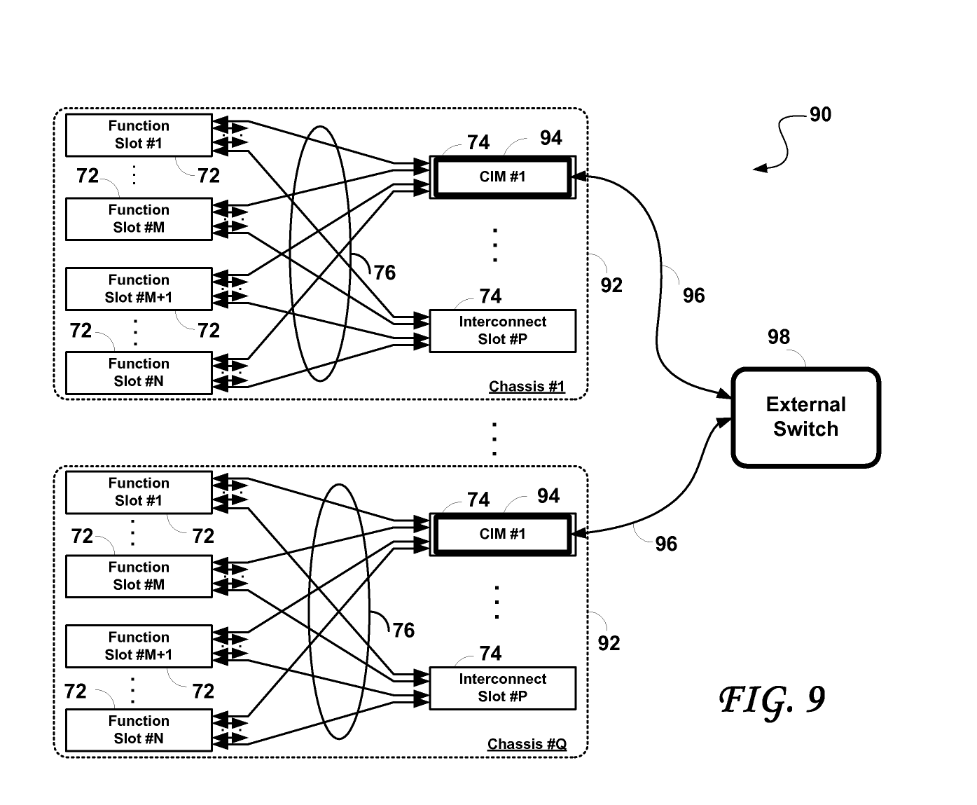

FIG. 9 is a block diagram illustrating a Multi-Chassis connectivity scheme 90 with a communication network provided by external switching (this is an inter chassis switching module which is connected to the chassis via external cables; the switching module may physically reside in one chassis, be distributed over multiple chassis, or housed in a separate chassis) according to an embodiment of the present invention. The multi-chassis connectivity scheme 90 includes a plurality Q of chassis 92, chassis link relays in the form of Connection Interface Modules (CIM) 94, transmission links 96, and an external switching point 98. Each CIM 94 is linked to the external switching point 98 through one of the transmission links 96. The multi-chassis connectivity scheme 90 is derived from a plurality Q of systems 70 of FIG. 7 by adding the Connection Interface Modules (CIM) 94 in one of the “P” interconnect switch slots 74, for example the Interconnect Slot #1, of each chassis 92.

The multi-chassis connectivity scheme 90 enables traffic to be switched between function modules 72 spanning multiple chassis. The transmission links 96, being capable of handling the bandwidth to the external switching point 98, may be electrically driven on copper or may be optical links. The Connection Interface Modules (CIM) 94 terminate the chassis connections (the bi-directional point-to-point links 76) and relays them across the transmission links 96 and vice-versa. Throughput may be scaled by providing, connected to each chassis 92, a plurality P copies (not illustrated) of the external switching point 98 in which case all external switching points 98 are preferably completely independent from each other. For each external switching point 98, one CIM 94 is added to each chassis.

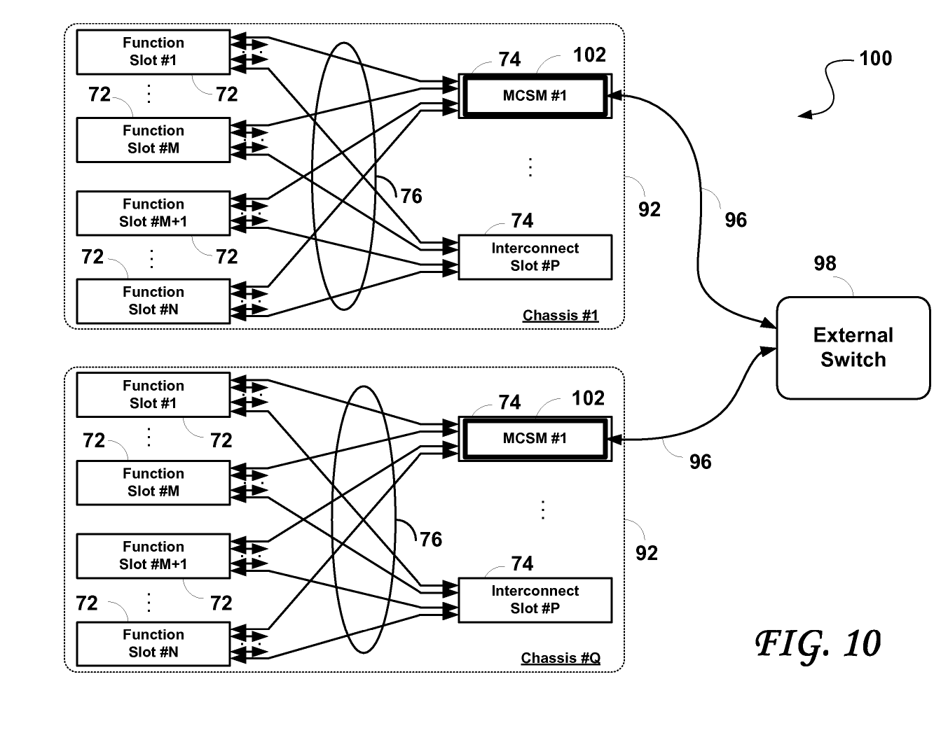

FIG. 10 is a block diagram illustrating a second Multi-Chassis connectivity scheme 100 with distributed chassis-based switching and external switching, according to an embodiment of the present invention. The second Multi-Chassis connectivity scheme 100 may be configured so as to enable (bandwidth between) function modules (in function slots 72) spanning multiple chassis to be switched. The second Multi-Chassis switching network 100 differs from the Multi-Chassis switching network 90 in that the CIMs 94 of the Multi-Chassis switching network 90 are replaced with Multi Chassis Switching Modules (MSCM) 102. In this topology, traffic between function modules in the same chassis may be switched locally. Only traffic that is destined for function modules located in other chassis need be transmitted out of the chassis for external inter-chassis switching. Bandwidth may be electrically switched locally in the MCSMs 102 and may be sent over the transmission links 96 (which may be copper or optical links) for external switching using one or more inter chassis switch modules (the external switch 98).

One of the characteristics of the bandwidth aggregation architecture of the second Multi-Chassis connectivity scheme 100 is that all bandwidth may leave the chassis (92), even though there is a local switch (the MCSM 102). This takes into account the case in which all traffic from and to function modules within one chassis is between function modules on different chassis. Another major advantage of the present bandwidth aggregation architecture is that the availability of bandwidth conveniently at one point means the most advanced high density transmission cables (e.g., optical or other technology) may be used for a dramatic reduction in cable count. Throughput may readily be scaled by replicating the external switching point 98 (network) P times. All networks are preferably completely independent. The MCSM can be also configured with a distributed switching architecture. This enables the intra chassis switching and inter chassis switching to take place without an explicit inter chassis switch. This logical topology is used for small systems or for larger systems where a bisectional bandwidth ratio of much less than 1 is suitable.

### EXEMPLARY EMBODIMENT I

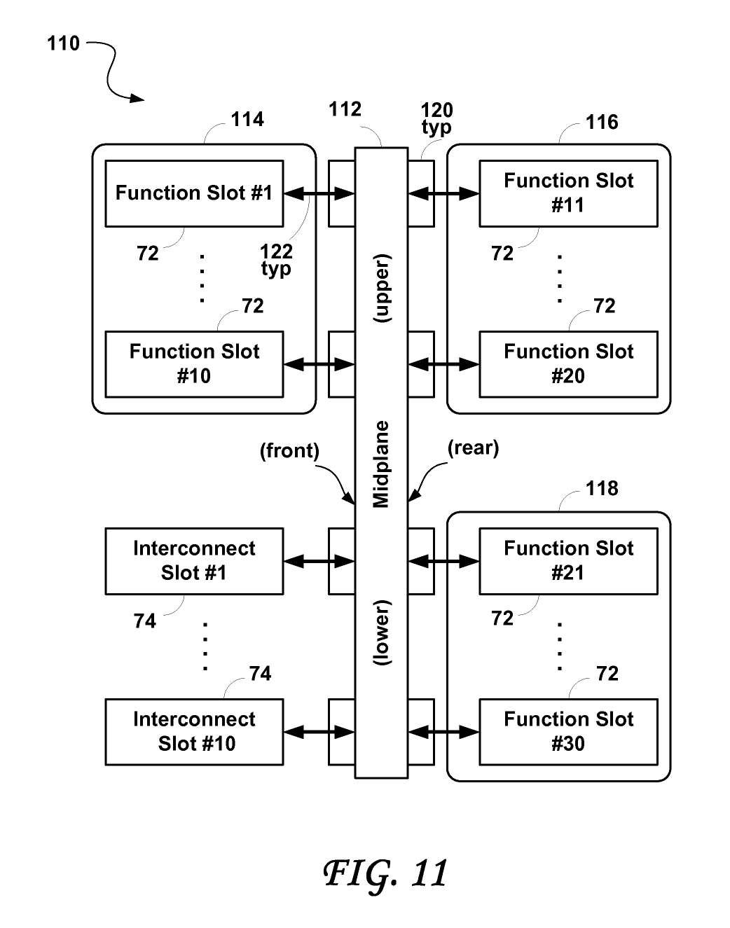

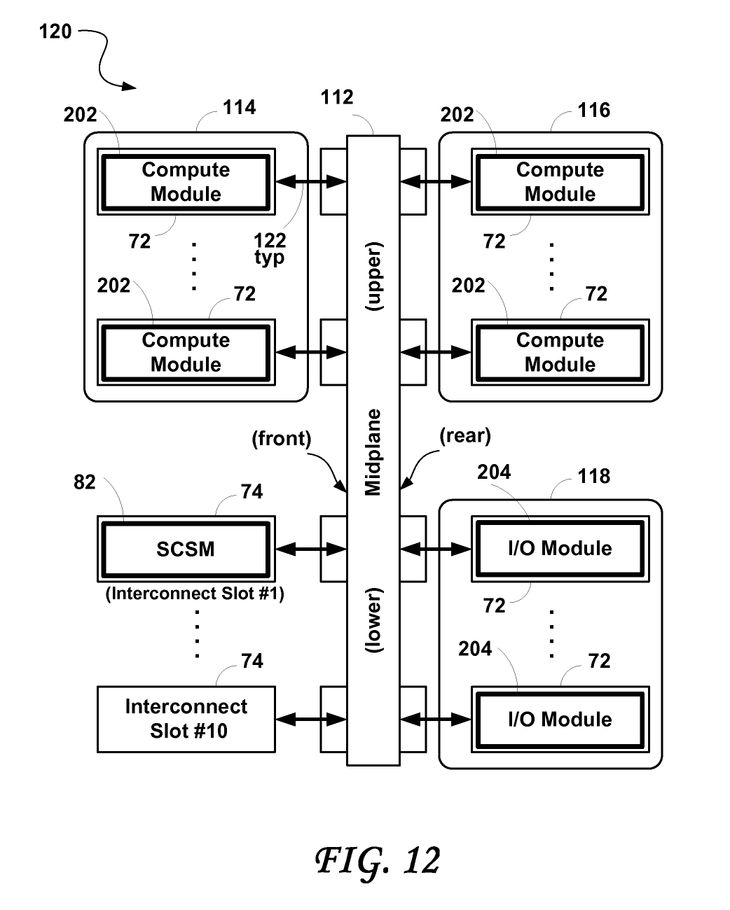

The connectivity system within the chassis, according to an embodiment of the present invention, may be based upon a midplane design. The midplane connectivity is shown in FIG. 11, illustrating a midplane based chassis 110, comprising a midplane 112 having a front and a rear face, and being divided into an upper and a lower section. The midplane supports, for example, 30 function slots 72 (Function Slot #1 to Function Slot #30), divided into three groups (114, 116, and 118) of 10 function slots each, accessing the upper front, upper rear, and lower rear sections of the midplane 112 respectively; and 10 interconnect slots 74. The function slots 72 and the interconnect slots 74 may be accessed from the midplane 112 via high performance electrical connectors 120 through links 122. The function slots 72 may be utilized to house a variety of functions (function modules) that support communications, computing and/or any other specialized application. For example, the 20 function slots 72 comprising the first and second groups (114 and 116) may be presented on the electrical connectors 120 at the top (upper part) of the midplane 112. Ten 10 of these 20 function slots (the first group 114) may be presented at the front of the midplane 112 and 10 of the function slots (the second group 116) may be presented at the rear of the midplane 112. The connectors for these 20 function slots (i.e. the groups 114 and 116) are preferably spaced to permit large physical modules to be connected when in the physical chassis. The upper function slots (i.e. the groups 114 and 116) may be used for the most demanding applications, since they have the largest space and cooling capacity in the chassis. Another ten of the function slots 72 (i.e. the group 118) may be presented at electrical connectors 120 in the lower rear of the midplane. The connectors for these 10 function slots (i.e. the group 118) may be spaced for smaller physical modules, and may be used for smaller functions such as I/O, but may alternatively be used for any function that fits within the space.

As mentioned above, the midplane 112 of this exemplary embodiment (the midplane based chassis 110) may support 10 interconnect slots 74 that may be accessed via high performance electrical connectors 120. The interconnect slots 74 may house logical interconnect capabilities that provide high performance connectivity between function modules within the chassis for a single chassis configuration, high performance extension of the chassis links for external switching, as well as high performance connectivity between function modules within and between chassis for multi-chassis configurations, as described in FIGS. 8-10 above. The 10 interconnect slots 74 may be presented at electrical connectors 120 in the lower front of the midplane 112. The connectors 120 for the interconnect slots 74 may be spaced for smaller physical modules.

Physical connectivity between the interconnect slots and function slots is provided by the links 122 through the connectors 120 and the midplane 112. The links 122 may include a set of full duplex (differential pair) lanes, and the connectivity may be as follows. The links 122 of each of the 30 function slots 72 (Function Slots #1 to #30) in this exemplary embodiment may include 10 links (each comprising a set of full duplex, differential pair lanes), that are routed, one set to each of the 10 interconnect slots 74 (Interconnect slots #1 to #10) through the midplane 112. Correspondingly, the links 122 of each of the 10 interconnect slots 74 may include thirty (30) links (each comprising a set of full duplex differential pair lanes), that are routed, one set to each of the 30 function slots 72. The bandwidth transmitted over these links may be a function of the electronic modules. For example, the individual lanes (which comprise the links 122) may be operated over a range of high speeds up to, for example, about 10 Gbps or higher. It is understood that the aggregate bandwidth transmitted over a link is a function of the bandwidth per lane and the number of lanes per link

With respect to network connectivity, and from a networking standpoint, each interconnect slot 74 may be completely independent and may represent 10 separate interconnect networks (or network planes as used in the network topology, FIGS. 9 and 10 above). Each function slot 72 may have access to multiple “network endpoints”, where 10 separate networks may terminate. The interconnect slots 74 may be configured as “bandwidth aggregation points” where each slot has access to 30 network endpoints (by way of the links going to and from the slot) in this exemplary embodiment. The midplane design permits more modules to be connected both from the front and the back of the chassis, at a separation that is sufficient to enable a practical design to be realized. However, embodiments of the present invention may readily be implemented that do not rely upon the midplane design or the stated specific number of function and interconnect modules. For example, embodiments of the present invention may be implemented that rely upon a backplane or other designs.

FIG. 12 shows an exemplary system 120 based on the midplane based chassis 110 of FIG. 11. The midplane 112 is connected with compute modules 202 (in the function slots #1 to #20, i.e. the function slots in the groups 114 and 116) and I/O modules 204 (in the function slots #21 to #30 i.e. the function slots in the group 118) installed and with one Single Chassis Switch Module 82 (SCSM, see FIG. 8). The SCSM 82, may be inserted in the interconnect slot #1 (74) so that the SCSM 82 may thus pick up the bandwidth from the 20 Compute Modules 202, and the up to 10 I/O modules 204. The amount of switching performed in the SCSM 82 depends upon the switch technology and the line rate of the links 122. For example, the links 122 may be being run at 2 GByte per second. By provisioning the switch slot with a switch module that can handle 60 GByte of switching, 2 Gbyte of switching may be provided between all compute modules and I/O modules.

The system 120 of FIG. 12 is an exemplary embodiment of a midplane according to the present invention, provisioned with an I/O module 204, 20 Compute Modules 72 and one switch 82. The terms “compute modules” and “I/O modules” are used as specific examples only and without limitation. As noted above, the networking is generic and will work with any function module. By provisioning the midplane with a 2^{nd} switch module, a total of 120 GByte (for example) of switching may be provided. This works out to 4 Gbyte switching between all compute modules and the I/O modules while maintaining a bisectional bandwidth ratio of 1. The addition of a 3rd, 4th, and 10th switch enables 6, 8, and 20 GByte per second throughput per function module respectively. It is to be noted that these numbers and link parameters are exemplary only. In fact, part of the intrinsic value of the present embodiments is that the performance thereof changes with new modules. This ability to scale throughput bandwidth at relatively low cost is believed to be unique to this topology. The switches may be hot inserted in service. By load balancing over all the switches (which may be carried out by the network endpoint controller, which forms no part of the present invention), the system may be operated as a multi-path fault tolerant self-healing system. All connections are preferably point-to-point, meaning that there are preferably no busses in this design. In turn, this means that no single point of failure with respect to electronics connected to the midplane or physical disturbances with the midplane (or connectors) can cause more than the point-to-point paths in question to be brought down. All switch networks (or planes) are preferably independent, meaning that failure within one network has no impact on any other network. There is preferably fully switched connectivity—compute module to compute module, compute module to I/O and I/O to I/O. The midplane design and the number of function slots, and interconnect slots, while not arbitrary, are not to be construed as limiting the scope of the inventions presented herein. Embodiments of the present invention may readily be scaled to include a greater or lesser number of interconnect slots or function slots. For example, for smaller markets, an embodiment of the present invention may be provided with a backplane having, for example, 10 function slots and 6 interconnect slots. Since the interconnect is scalable and modular, it is straightforward to map it onto multiple physical instantiations. The switching described herein has been provisioned for maintaining an advantageous bisectional bandwidth ratio (BB ratio) of 1 between compute modules. However, it may be that the target application does not have heavy computer IPC (inter-processor communications), so a smaller switched bandwidth may be provisioned for cost reasons, which is another advantage of the modular approach presented herein. Embodiments of the present invention find usage in converged computer and communication applications. In this case, there may be as much interconnect capacity between I/O as between computers so the switch bandwidth may be raised to provide a BB ratio of 1 over the 20 compute modules and the 10 I/O modules described relative to the exemplary embodiment of FIG. 12.

Scaling Beyond the Chassis

A major problem associated with existing blade servers is that they do not scale beyond the chassis. External networking, cabling and associated management must be added to connect them together. The use of external switch equipment means delivering a highly scalable network with a bisectional bandwidth ratio of 1 often becomes impossible or impractical. This becomes even more of an issue as throughput requirements increase, and in many cases it is not possible to get the bandwidths out of the system to permit throughput scaling. In addition, acquisition cost, management cost, cabling overheads and latency goes up substantially and non-linearly as the number of network stages increases to cope with the scale of the network.

The present architecture features built in seamless scaling beyond the chassis. The interconnect slots 74 are bandwidth articulation points that have access to bandwidth arriving from each of the function slots 72 that house the compute modules, I/O modules or other specialized functions. To provide switching beyond the chassis and to maintain a bisectional bandwidth ratio of 1 (between compute, other functional and I/O modules) a capability is required that can switch the same amount of bandwidth between all of the compute, other functional and I/O modules within the chassis but also switch the same amount of bandwidth out of the chassis for connectivity to compute, other functional and I/O modules in other chassis. This may be done with an MCSM module (Multi-Chassis Switch Module).

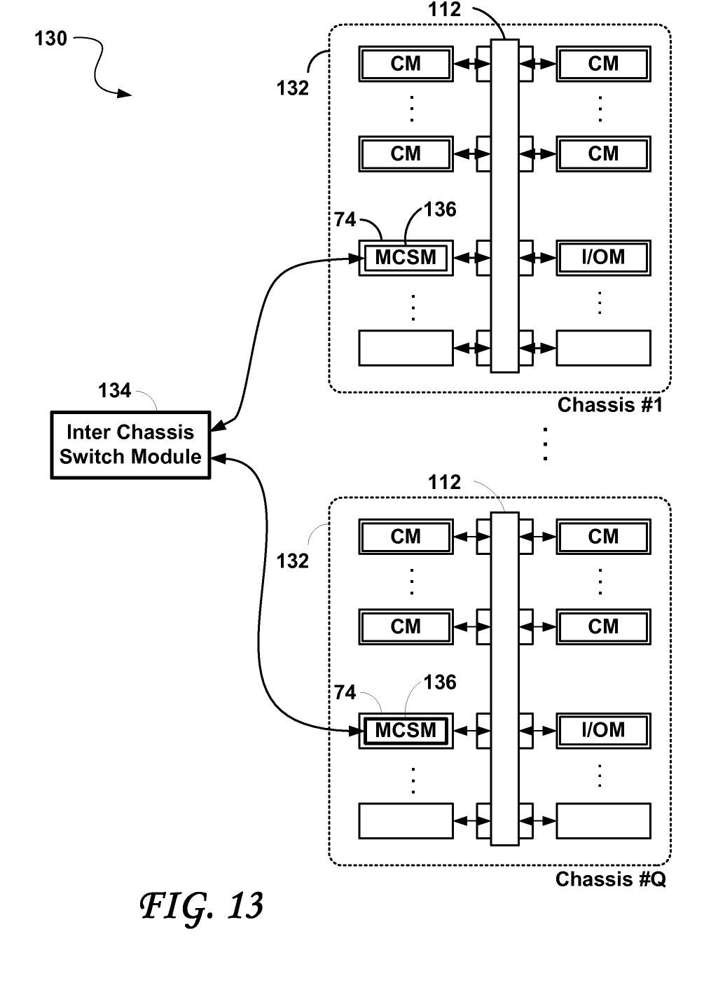

FIG. 13 shows a Multi-Chassis system 130. The Multi-Chassis system 130 is comprised of a plurality of multi-chassis chassis 132 (Chassis #1 to Chassis #Q) each of which is derived from the midplane based chassis 110 of FIG. 11, and at least one Inter Chassis Switch Module 134 (ICSM).

Each Multi-Chassis system 130 comprises one or more Multi-Chassis Switch Modules 136 (MCSM), each MCSM 136 inserted in an interconnect slot 74 of the respective multi-chassis chassis 132.

In this exemplary embodiment, each MCSM 136 provides internal switching (i.e. internal to the multi-chassis chassis 132 in which it is inserted) but also makes all of the bandwidth available for switching connections to other compute, functional or I/O modules located in other multi-chassis chassis 132 over a network that may be provided with the Inter Chassis Switch Module 134 (ICSM). The ICSM 134 may be introduced to provide the second stage of switching between the plurality of chassis 132. As described above, presented herein is a bandwidth aggregation architecture that flexibly takes all bandwidth out from function slots 72 and makes it available at the interconnect slots 74 for convenient processing of switched bandwidth, irrespective of the ultimate network topology.

The MCSM 136 may be provisioned in the midplane 112 of each chassis 132 and networked via the ICSM 134, according to an embodiment of the present invention. As with the single chassis case, adding within each chassis 132 a 2nd, 3rd or 10th MCSM 136 (along with the associated ICSM's 134) enables 4, 6, and 20 Gbyte (in this exemplary embodiment) of interconnect respectively between all compute modules, functional modules, and I/O modules in the network. Multi-chassis scaling may be carried out, according to an embodiment of the present invention, with distributed chassis based switches (MCSM) 136 and one or more external switches (ICSM 134). In the present multi-chassis network topology (i.e. the multichassis system 130), each chassis 132 may have a midplane 112 that provides the first stage of switching (in the respective MCSMs 136). A second stage of switching may be provided by the ICSM 134.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed:

1. An interconnect system, comprising:
a chassis;
a plurality N of function modules housed in the chassis, and
an interconnect facility, the interconnect facility including:
a plurality P of switch planes, and
a plurality of point-to-point links, each of the plurality of point-to-point links having a first end coupled to one of the plurality N of function modules and a second end coupled to one of the plurality P of switch planes such that each of the plurality P of switch planes is coupled to each of the plurality N of function modules by one of the plurality of point-to-point links.

2. The interconnect system of claim 1, wherein each of the plurality P of switch planes adds 1/p^{th} incremental bandwidth to the interconnect system and wherein a maximum bandwidth of the interconnect system is equal to a product of P and a bandwidth of the plurality of point-to-point links.

3. The interconnect system of claim 1, wherein each of the plurality P of switch planes is independent of others of the plurality of P switch planes.

4. The interconnect system of claim 1, wherein each of the plurality N of function modules may be configured for at least one of I/O functions, visualization functions, processing functions, and to provide network connectivity functions.

5. The interconnect system of claim 1, wherein each of the plurality of point-to-point links is bi-directional.

6. The interconnect system of claim 1, wherein each of the plurality of links includes a cable.

7. The interconnect system of claim 1, wherein each of the plurality of links includes at least one electrically conductive track disposed on a substrate.

8. A method for providing interconnectivity in a computer, comprising steps of:
providing a chassis, the chassis including N function slots and P interconnect slots for accommodating up to N function modules and up to P interconnect modules;
providing a plurality of bi-directional point-to-point links;
coupling respective ones of the plurality of links between each of the N function slots and each of the P interconnect slots, wherein the coupling step is effective to provide a total available switched bandwidth B in the chassis, the total available bandwidth B being defined as a product of P and a bandwidth of the plurality of bi-directional point-to-point links.

9. The method of claim 8, wherein the providing step is carried out with the plurality of bi-directional point-to-point links each including at least one electrically conductive track disposed on a substrate.

10. A computer chassis, comprising:
a plurality N of function slots, each of the plurality N of function slots being configured to accommodate a function module;
a plurality P of interconnect slots, each of the plurality P of interconnect slots being configured to accommodate an interconnect module, and
a plurality of bi-directional point-to-point links, each of the plurality of bi-directional point-to-point links having a first end coupled to one of the plurality N of function slots and a second end coupled to one of the plurality P of interconnect slots such that each of the plurality P of interconnect slots is coupled to each of the plurality N of function slots by one of the plurality of bi-directional point-to-point links.

11. The computer chassis of claim 10, each of the plurality of bi-directional point-to-point links includes a cable.

12. The computer chassis of claim 10, wherein each of the plurality of bi-directional point-to-point links includes at least one electrically conductive track disposed on a substrate.

13. The computer chassis of claim 10, wherein each of the plurality P of interconnect slots is configured to accommodate an independent communication network.

14. The computer chassis of claim 10, further including a function module inserted in at least one of the plurality N of function slots.

15. The computer chassis of claim 10, wherein the function module is operative to carry out at least one of I/O functions, visualization functions, processing functions, and to provide network connectivity functions.

16. The computer chassis of claim 10, further including an interconnect module inserted in at least one of the plurality P of interconnect slots.

17. The computer chassis of claim 10, further including a switch module inserted into one of the plurality of P of interconnect slots, the switch module being operative to activate 1/p^{th} of a total available switched bandwidth B in the chassis.

18. The computer chassis of claim 17, wherein the total available switched bandwidth B is a product of P and a bandwidth of each bi-directional point-to-point link.

19. The computer chassis of claim 10, further including:
a plurality of function modules, each of the plurality of function modules being inserted in a respective one of the plurality N of function slots, and
a single chassis switch module inserted into one of the plurality of P of interconnect slots, the single chassis switch module being configured to provide switched connectivity between the plurality of function modules.

20. A multichassis computer connectivity system, comprising:
a first chassis including a plurality N₁ of function slots, each configured to accommodate a function module; a plurality P₁ of interconnect slots, each configured to accommodate an interconnect module, each of the plurality P₁ of interconnect slots being coupled to each of the plurality N₁ of function slots by respective first bi-directional point-to-point links, and a first connection interface module inserted into one of the plurality P₁ of interconnect slots;
a second chassis including a plurality N₂ of function slots, each configured to accommodate a function module; a plurality P₂ of interconnect slots, each configured to accommodate an interconnect module, each of the plurality P₂ of interconnect slots being coupled to each of the plurality N₂ of function slots by respective second bi-directional point-to-point links, and a second connection interface module inserted into one of the plurality P₂ of interconnect slots, and
an external switch coupled to the first and second connection interface modules, the first and second connection interface modules and the external switch being configured to enable traffic to be switched between any one of the plurality N₁ of function slots and any one of the plurality N₂ of function slots.

21. The multichassis computer connectivity system of claim 20, wherein the external switch is coupled to the first and second connection interface modules relays by first and second electrically driven links.

22. The multichassis computer connectivity system of claim 20, wherein the external switch is coupled to the first and second connection interface modules by first and second optically driven links.

23. The multichassis computer connectivity system of claim 20, wherein each of the respective first and second bi-directional point-to-point links includes a cable.

24. The multichassis computer connectivity system of claim 20, wherein each of the respective first and second bi-directional point-to-point links includes at least one electrically conductive track disposed on a substrate.

25. The multichassis computer connectivity system of claim 20, wherein each of the plurality P₁ and P₂ of interconnect slots is configured to accommodate an independent communication network.

26. The multichassis computer connectivity system of claim 20, further including:
a first function module inserted in at least one of the plurality N₁ of function slots, and
a second function module inserted in at least one of the plurality N₂ of function slots.

27. The multichassis computer connectivity system of claim 26, wherein the first and second function modules are operative to carry out at least one of I/O functions, visualization functions, processing functions, and to provide network connectivity functions.

28. The multichassis computer connectivity system of claim 20, further including:
a first interconnect module inserted in at least one of the plurality P₁ of interconnect slots, and
a second interconnect module inserted in at least one of the plurality P₂ of interconnect slots.

29. The multichassis computer connectivity system of claim 20, wherein the first connection interface module is configured to switch traffic between the plurality N₁ of function slots without routing the traffic to the external switch.

30. The multichassis computer connectivity system of claim 20, wherein the second connection interface module is configured to enable traffic between the plurality N₂ of function slots without routing the traffic to the external switch.

31. The multichassis computer connectivity system of claim 20, wherein the first connection interface module is configured to switch traffic from one of the plurality N₁ of function slots through the external switch only when the traffic is destined to one of the plurality N₂ of function slots.

32. The multichassis computer connectivity system of claim 20, wherein the second connection interface module is configured to switch traffic from one of the plurality N₂ of function slots through the external switch only when the traffic is destined to one of the plurality N₁ of function slots.

33. A computer chassis, comprising:
a midplane;
a plurality of connectors coupled to the midplane;
a plurality N of function slots, each of the plurality N of function slots being configured to accommodate a function module;
a plurality P of interconnect slots, each of the plurality P of interconnect slots being configured to accommodate an interconnect module to enable traffic to be selectively switched, through the plurality of connectors and the midplane, between the plurality N of function slots and between any one of the plurality N of function slots and a network external to the computer chassis, and
a plurality of full-duplex point-to-point links, each of the full duplex point-to-point links being coupled between one of the plurality N of function slots and one of the plurality of connectors or between one of the plurality P of interconnect slots and one of the plurality of connectors.

34. The computer chassis of claim 33, wherein each of the plurality P of interconnect slots is configured to accommodate an independent communication network.

35. The computer chassis of claim 33, further including a function module inserted in at least one of the plurality N of function slots.

36. The computer chassis of claim 35, wherein the function module is operative to carry out at least one of I/O functions, visualization functions, processing functions, and to provide network connectivity functions.

37. The computer chassis of claim 33, further including an interconnect module inserted in at least one of the plurality P of interconnect slots.

38. The computer chassis of claim 37, wherein the interconnect module includes a switch module, the switch module being operative to activate 1/p^{th} of a total available switched bandwidth in the computer chassis.

39. The computer chassis of claim 33, further including:
a plurality of function modules, each of the plurality of function modules being inserted in a respective one of the plurality N of function slots, and
a single chassis switch module inserted into one of the plurality of P of interconnect slots, the single chassis switch module being configured to provide switched connectivity between the plurality N of function modules within the computer chassis.

40. The computer chassis of claim 33, further including a connection interface module inserted into one of the plurality P of interconnect slots, the connection interface module being configured to enable traffic to be switched between any one of the plurality P of function modules and a network external to the computer chassis through an external switch.

41. The computer chassis of claim 33, wherein each of the plurality of full-duplex point-to-point links includes at least one electrically conductive track disposed on a substrate.

42. The computer chassis of claim 33, wherein each of the plurality P of interconnect slots is configured to accommodate an independent communication network.

43. The computer chassis of claim 35, wherein the function module is operative to carry out at least one of I/O functions, visualization functions, processing functions, and to provide network connectivity functions.

44. The computer chassis of claim 40, wherein the connection interface module is configured to switch traffic between the plurality N of function slots without routing the traffic to a switch that is external to the computer chassis.

45. The computer chassis of claim 33, further including:
a plurality of compute modules inserted into respective ones of the plurality N of function slots, each of the plurality of compute modules including at least one processor;
a plurality of I/O modules inserted in respective other ones of the plurality N of function slots, and
at least one switching module inserted in one of the plurality P of interconnect slots, the at least one switching module being configured to switch traffic between any one of the compute and I/O modules within the computer chassis.

46. A multichassis computational system, comprising:
a first chassis, the first chassis including a first midplane; a plurality N₁ of function slots, each being coupled to the first midplane and configured to accommodate a function module; a plurality P₁ of interconnect slots, each being coupled to the first midplane, configured to accommodate an interconnect module and being coupled to each of the plurality N₁ of function slots; and a first multi chassis switch module inserted into one of the plurality P₁ of interconnect slots;
a second chassis, the second chassis including a second midplane; a plurality N₂ of function slots, each being coupled to the second midplane and configured to accommodate a function module; a plurality P₂ of interconnect slots, each being coupled to the second midplane, configured to accommodate an interconnect module and being coupled to each of the plurality N₂ of function slots; and a second multi chassis switch module inserted into one of the plurality P₂ of interconnect slots, and
an inter chassis switch module coupled to each of the first and second multi chassis switch module and configured to switch traffic between any of the plurality N₁ of function slots through the first multi chassis switch module and any of the plurality N₂ of function slots through the second multi chassis switch module.

47. The multichassis computational system of claim 46, wherein the inter chassis switch module is external to at least one of the first and second chassis.

48. The multichassis computational system of claim 46, further including:
a first plurality of conductors coupled to the first midplane, and
a first plurality of full-duplex point-to-point links, each of the first plurality of full duplex point-to-point links being coupled between one of the plurality N₁ of function slots and one of the first plurality of conductors or between one of the plurality P₁ of interconnect slots and one of the first plurality of connectors.

49. The multichassis computational system of claim 46, further including:
a second plurality of conductors coupled to the second midplane, and
a second plurality of full-duplex point-to-point links, each of the second plurality of full duplex point-to-point links being coupled between one of the plurality N₂ of function slots and one of the plurality of conductors or between one of the plurality P₂ of interconnect slots and one of the second plurality of connectors.

50. The multichassis computational system of claim 46, wherein each of the plurality P₁ and P₂ of interconnect slots is configured to accommodate an independent communication network.

51. The multichassis computational system of claim 46, further including a first function module inserted in at least one of the plurality N₁ of function slots and a second function module inserted in at least one of the plurality N₂ of function slots.

52. The multichassis computational system of claim 51, wherein the first and second function modules are operative to carry out at least one of I/O functions, visualization functions, processing functions, and to provide network connectivity functions.

53. The multichassis computational system of claim 46, further including a first interconnect module inserted in one of the plurality P₁ of interconnect slots and a second interconnect module inserted in one of the plurality P₂ of interconnect slots.

54. The multichassis computational system of claim 46, wherein the first multi chassis switch module is also configured to switch traffic from one of the plurality N₁ of function slots to any other one of the plurality N₁ of function slots without routing the traffic outside of the first chassis.

55. The multichassis computational system of claim 46, wherein the second multi chassis switch module is also configured to switch traffic from one of the plurality N₂ of function slots to any other one of the plurality N₂ of function slots without routing the traffic outside of the second chassis.

56. The multichassis computational system of claim 48, wherein each of the first plurality of full-duplex point-to-point links includes at least one electrically conductive track disposed on a substrate.

57. The multichassis computational system of claim 49, wherein each of the second plurality of full-duplex point-to-point links includes at least one electrically conductive track disposed on a substrate.

58. The multichassis computational system of claim 46, wherein each of the plurality P₁ and P₂ of interconnect slots is configured to accommodate an independent communication network.

59. The multichassis computational system of claim 46, wherein the first chassis further includes:
a first plurality of compute modules inserted into respective ones of the plurality N₁ of function slots, each of the first plurality of compute modules including at least one processor;
a first plurality of I/O modules inserted in respective other ones of the plurality N₁ of function slots, and wherein the first multi chassis switch module is further configured to switch traffic between any one of the first plurality of compute and I/O modules within the first chassis.

60. The multichassis computational system of claim 46, wherein the second chassis further includes:
a second plurality of compute modules inserted into respective ones of the plurality N₂ of function slots, each of the second plurality of compute modules including at least one processor;
a second plurality of I/O modules inserted in respective other ones of the plurality N₂ of function slots, and wherein the second multi chassis switch module is further configured to switch traffic between any one of the second plurality of compute and I/O modules within the second chassis.
